(19) United States
(12) Patent Application Publication
(10) Pub. No.: US 2018/0143803 A1
(43) Pub. Date: May 24, 2018

(54) PROACTIVE DEEP-ANALYSIS VIRTUAL ASSISTANT APPLICATION AND INTEGRATION

(71) Applicant: The HintBox!, Inc., San Francisco, CA (US)

(72) Inventor: David J. La Placa, San Francisco, CA (US)

(21) Appl. No.: 15/872,559

(22) Filed: Jan. 16, 2018

Related U.S. Application Data
(63) Continuation of application No. 15/335,407, filed on Oct. 26, 2016, now abandoned.
Application No. 15/335,407 is a continuation-in-part of application No. 15/206,231, filed on Jul. 9, 2016, now abandoned.
(60) Provisional application No. 62/349,060, filed on Jun. 12, 2016.
(60) Provisional application No. 62/348,946, filed on Jun. 12, 2016.

(51) Int. Cl. G06F 3/16; G06F 3/0481; G06F 17/30

(52) U.S. Cl. CPC G06F 3/167; G06F 17/30867; G06F 3/0481

(57) ABSTRACT

A virtual assistant AI system that may be connected to a wide variety of user accounts such as financial accounts, social media, news, shopping, utilities and service providers, travel accounts, and other account types. The AI then continually monitors connected accounts for changes, analyzes changes when they occur and identifies any relationships or interactions between accounts and potential or actual implications of changes, and generates proactive notifications and provides them to the user who may then further investigate using virtual assistant AI clients.

### CROSS-REFERENCE TO RELATED APPLICATIONS

This application is a continuation of U.S. patent application Ser. No. 15/335,407 titled “PROACTIVE DEEP-ANALYSIS VIRTUAL ASSISTANT APPLICATION AND INTEGRATION”, filed on Oct. 26, 2016, which claims the benefit of, and priority to, U.S. provisional patent application Ser. No. 62/349,060, titled, “PROACTIVE DEEP-ANALYSIS VIRTUAL ASSISTANT APPLICATION AND INTEGRATION”, which was filed on Jun. 12, 2016, and is also a continuation-in-part of U.S. patent application Ser. No. 15/206,231, titled, “VIRTUAL ASSISTANT PLATFORM WITH DEEP ANALYTICS, EMBEDDED AND ADAPTIVE BEST PRACTICES EXPERTISE, AND PROACTIVE INTERACTION”, which was filed on Jul. 9, 2016, which claims the benefit of, and priority to, U.S. provisional patent application Ser. No. 62/348,946, titled, “VIRTUAL ASSISTANT PLATFORM WITH DEEP ANALYTICS AND PROACTIVE INTERACTION”, which was filed on Jun. 12, 2016, the entire specification of each of which is incorporated herein by reference in their entirety.

### BACKGROUND OF THE INVENTION

### Field of the Art

The disclosure relates to the field of artificial intelligence, and more particularly to the field of virtual personal assistants.

### Discussion of the State of the Art

Virtual assistants are a growing field of artificial technology and continue to offer new ways for users to interact and make requests, but such technologies tend to focus on reactive interaction wherein users ask questions or make requests, and the virtual assistant responds to that immediate demand before returning to an idle state. A large benefit to having a personal assistant (virtual or otherwise) is the ability to delegate minor tasks and responsibilities like monitoring calendar tasks, relevant news, travel arrangements, or financial information, yet virtual assistants rely on user requests to provide information and therefore do an imperfect job of relieving the user of the additional effort of monitoring and checking this information.

What is needed, is a new form of virtual assistant that monitors user accounts and information and proactively identifies relationships and interactions between accounts, and that then proactively interacts with the user so that the virtual assistant can fully handle the monitoring and analysis of a user's personal information and notify the user only when their attention is needed.

### SUMMARY OF THE INVENTION

Accordingly, the inventor has conceived and reduced to practice, in a preferred embodiment of the invention, a virtual assistant platform with deep analytics and proactive interaction.

The invention comprises a virtual assistant AI system that may be connected to a wide variety of user accounts such as financial accounts, social media, news, shopping, utilities and service providers, travel accounts, and other account types. The AI then continually monitors connected accounts for changes, analyzes changes when they occur and identifies any relationships or interactions between accounts and potential or actual implications of changes, such as if a news article mentions events affecting a company in a user's investment portfolio. The AI then generates proactive notifications and provides them to the user, such as notification alerts, reminders, suggestions, or prompts for action such as notifying a user of the news event that may impact their investment, and asking if they wish to take action on that company's stock.

According to a preferred embodiment of the invention, a system for providing real-time multidevice messages to a user, comprising: a first computing device comprising a memory, a processor, an audio input component, an audio output component, a wireless network interface, and a plurality of programming instructions operating in the memory and on the processor, the programming instructions configured to: receive a verbal query from a user via the audio input device; transmit the verbal query via a wireless network using the wireless network interface to a virtual assistant platform; receive a query response message from the virtual assistant platform and provide the query response message to the user using the audio output device; receiving a verbal instruction from the user to provide information visually; and transmitting the verbal instruction to the virtual assistant platform; and a second computing device comprising a memory, a processor, a display, an input means, a network interface, and a plurality of programming instructions operating in the memory and on the processor, the programming instructions configured to: receive a data message from the virtual assistant platform via a network, the data message based at least in part on the verbal instruction from the user; displaying graphically at least a portion of data from the received data message on the display; receiving a user interaction event pertaining to the displayed data based on use of the input means; and transmitting a message to the virtual assistant platform via the network based on the user interaction event, is disclosed.

According to another preferred embodiment of the invention, a method for providing real-time multidevice messages to a user, comprising the steps of: receiving, at a first computing device comprising a memory, a processor, an audio input component, an audio output component, a wireless network interface, and a plurality of programming instructions operating in the memory and on the processor, a verbal query from a user via the audio input device; transmit the verbal query via a wireless network using the wireless network interface to a virtual assistant platform; receive a query response message from the virtual assistant platform and provide the query response message to the user using the audio output device; receiving a verbal instruction from the user to provide information visually; transmitting the verbal instruction to the virtual assistant platform; receiving, at a second computing device comprising a memory, a processor, a display, an input means, a network interface, and a plurality of programming instructions operating in the memory and on the processor, a data message from the virtual assistant platform via a network, the data message based at least in part on the verbal instruction from the user; displaying graphically at least a portion of data from the received data message on the display; receiving a user interaction event pertaining to the displayed data based on use of the input means; and transmitting a message to the virtual assistant platform via the network based on the user interaction event, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary system architecture for a virtual assistant platform with deep analytics and proactive interaction, according to a preferred embodiment of the invention.

FIG. 2 is a flow diagram illustrating an exemplary overview method for operating a virtual assistant platform with deep analytics and proactive interaction, according to a preferred embodiment of the invention.

FIG. 3 is a flow diagram illustrating an exemplary method for operating a virtual assistant with deep analytics and proactive interaction, illustrating an exemplary use case of deep analytics insights to generate personalized notifications for a user.

FIG. 4 is a block diagram illustrating an exemplary hardware architecture of a computing device used in an embodiment of the invention.

FIG. 5 is a block diagram illustrating an exemplary logical architecture for a client device, according to an embodiment of the invention.

FIG. 6 is a block diagram showing an exemplary architectural arrangement of clients, servers, and external services, according to an embodiment of the invention.

FIG. 7 is another block diagram illustrating an exemplary hardware architecture of a computing device used in various embodiments of the invention.

FIG. 8 is a flow diagram illustrating the use of a virtual assistant with deep analytics and proactive interaction for predicting and managing the impact of a global event, illustrating processing of an oil refinery accident and its impact on markets and users.

FIG. 9 is a flow diagram illustrating the use of a virtual assistant with deep analytics and proactive interaction for assisting a user with a financial trade, illustrating the use of historical analysis and proactive notification to provide the user with a recommendation.

FIG. 10 is a flow diagram illustrating the use of a “batting average” algorithm to assist users with financial decisions.

FIG. 11 is a process diagram showing how user notifications are generated from events regarding assets, according to an embodiment of the invention.

FIG. 12 is a data flow diagram showing various data sources and objects in relation to users, according to an embodiment of the invention.

FIG. 13 is a process and data flow diagram showing sequential flow of data and actions leading to user notification, according to an embodiment of the invention.

FIG. 14 is a diagram illustrating an exemplary process flow diagram showing how partial status vectors lead to user notifications, according to an embodiment of the invention.

FIG. 15 is a table showing a typical status vector, according to an embodiment of the invention.

FIG. 16 is a diagram showing communication flow from status vectors to user messages, according to an embodiment of the invention.

FIG. 17 is a method diagram for computing batting averages and triggering rules by trading activity of a user, according to an embodiment of the invention.

FIG. 18 shows a hierarchical data arrangement, according to an embodiment of the invention.

FIG. 19 is an exemplary decision tree, according to an embodiment of the invention.

FIG. 20 is an exemplary decision tree, according to an embodiment of the invention.

FIG. 21 an exemplary decision tree, according to an embodiment of the invention.

FIG. 22 is a conceptual diagram showing different asset classes and goals, according to an embodiment of the invention.

FIG. 23 is an illustration of an exemplary user interface for a virtual assistant application, illustrating an exemplary proactive notification display and a user portfolio management interface, according to a preferred embodiment of the invention.

FIG. 24 is a block diagram of an exemplary system architecture, illustrating the integration of a virtual assistant with deep analytics and proactive interaction with third-party virtual assistant products to extend their functionality.

FIG. 25 is a diagram of an exemplary system architecture, illustrating the use of a mixed audio and visual interaction system for financial information retrieval according to a preferred embodiment of the invention.

FIG. 26 is a flow diagram illustrating exemplary function of the mixed audio and visual interaction method available for financial information retrieval according to a preferred embodiment of the invention.

FIG. 27 is a flow diagram illustrating an exemplary method for providing real-time multidevice messages to a user, according to a preferred embodiment of the invention.

### DETAILED DESCRIPTION

The inventor has conceived, and reduced to practice, in a preferred embodiment of the invention, a virtual assistant platform with deep analytics and proactive interaction.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

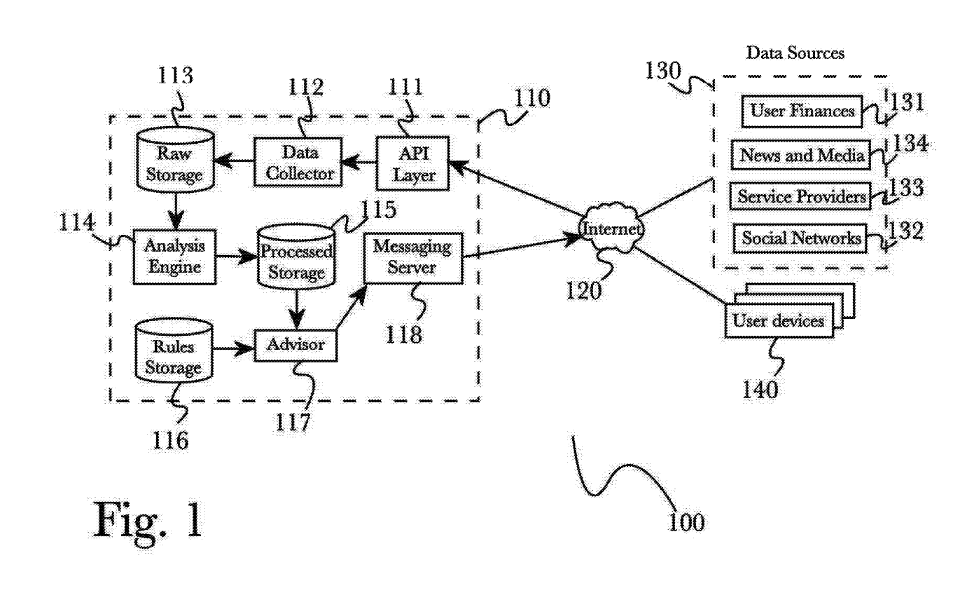

FIG. 1 is a block diagram illustrating an exemplary system architecture 100 for a virtual assistant platform 110 with deep analytics and proactive interaction, according to a preferred embodiment of the invention. According to the embodiment, virtual assistant platform 110 may connect via the Internet 120 or other data communication network, to interact with a computing device 140 (for example, a user's smartphone or computer) and a plurality of data sources 130 that may comprise a wide variety of information sources such as user financial accounts 131 (such as investment portfolios or bank accounts), social media profiles 132, accounts with service providers 133 such as public utilities or cloud services, news or other media sources 134, and other various sources of available information, whether public or private (with corresponding configuration for access). Data from sources 130 may be exposed using a plurality of application programming interfaces (APIs) 111 configured to facilitate communication between data sources 130 and a data collector 112 that receives raw data from connected data sources 130 and stores the data in a raw data storage database 113. This raw data may then be processed by an analysis engine 114 to produce entities for internal use such as to maintain a hierarchical structure as described below, as well as to identify any information changes such as new data or modifications to previously-received data (for example, when a stock price changes, or new posts are uploaded to a social media account, or new travel arrangements are made). Processed data may then be placed in a processed information storage database 115, which may optionally be a separate database structure or physical storage from a raw storage 113, or may simply be a logical separation within the same storage schema.

An intelligent advisor 117 may then retrieve processed data from storage 115 and load configured rules from a rules database 116 (such as rules governing a user's preferences for notifications, thresholds for determining whether a change is significant, timing for updates, or other such configuration information), and may analyze the data to identify relationships between data points (such as identifying that a user has family nearby a newly-booked travel destination, or that they have invested in a company that was mentioned in a recent news article) and to determine (optionally based on a plurality of configured rules) whether any particular change will impact related data entities and whether a user should be notified. For example, if a news article mentions a company in which the user holds stock, but it is only a passing reference, the user may not be notified as the implications of this observation are negligible. However, if a news article discusses a potential merger between companies, or a change in a product timeline, a user may be notified as this news may impact their stock. Notification prompts may then be provided to a messaging server 118 that may operate a plurality of messaging interfaces to accommodate a wide range of user preferences such as to communicate via email, SMS, SKYPE™, push notifications to a user's smartphone or other mobile device, or other such communication methods. Notifications may then be produced and transmitted via network 120 to a user's client device 140 for review.

According to the embodiment, notifications produced based on data insights and provided to a user may vary in nature, for example they may include simple push notification alerts to inform the user of an event, or they may be more complex or interactive such as a prompt for action or a proactive request being made of the user. For example, if it is determined that the user has family near a new travel destination, they may be prompted to schedule a lunch with their relatives based on known calendar and travel data. Additionally, by combining information from their family members (if available, according to a particular arrangement or configuration), it may be possible to automatically select an ideal time to schedule a meeting that will not conflict with the calendars of any involved parties. Another exemplary notification type may be a proactive suggestion provided to the user, such as when a news article mentions a potential product shift from a company in which the user holds stock. The user may be presented with a suggestion regarding their stock holdings, based on the inferred relationship between the user's financial profile and the news article, and optionally incorporating historical data such as past stock performance for this company or the user's past investment behavior. In this manner, it can be appreciated that the virtual assistant platform 110 provides a variety of proactive functionality to users that is not possible with current technologies, offering personalized suggestions and “reaching out” to a user when necessary without requiring a user to track their own accounts and manually take action.

According to the embodiment, a variety of algorithm-based approaches and data organizational schema may be used to process and analyze data from sources. For example, an internal storage of a user's information and accounts may be modeled as a hierarchical structure of “titles”, each title referring to a configured account, profile, or other significant piece of user information that may be monitored for changes and interactions with other titles. Each title communicates with its relevant and defined data sources (such as associated bank accounts, stock tickers, or other information source associated with a configured user account) as to create “status vectors” representing the flow of information from a data source to a title and ultimately to a user. Communication may occur according to defined parameters such as an operating mode or interval, for example to update information (checking for any changes, analyzing any new information, etc.) every 15 minutes. When a change is identified within any title, the status vector may be delivered to the title entity and used to notify the user. Index entities may be used internally to refer to discrete portions of information within titles, such as a particular stock's last closing price or a user's social media feed. Every title and index entity may be assigned its own status vector, and status vectors may be aggregated from all significant data pushed to these internal entities by all related APIs.

A user entity may be internally used to represent a human user, and to organize and manage all of the user's data (this may be thought of as a container into which the title hierarchy is placed to associate everything with a user and keep user information separate from other users' information). The status vector of a user entity is created from all evaluated titles, and this entity may have a data space comprising historical data used to prepare reports and statistics, and a plurality of entity properties that may be used as drivers for evaluation (such as, for example, “type of investor” or “strength of social network presence”) and that may comprise all communication details for the user.

### DETAILED DESCRIPTION OF EXEMPLARY EMBODIMENTS

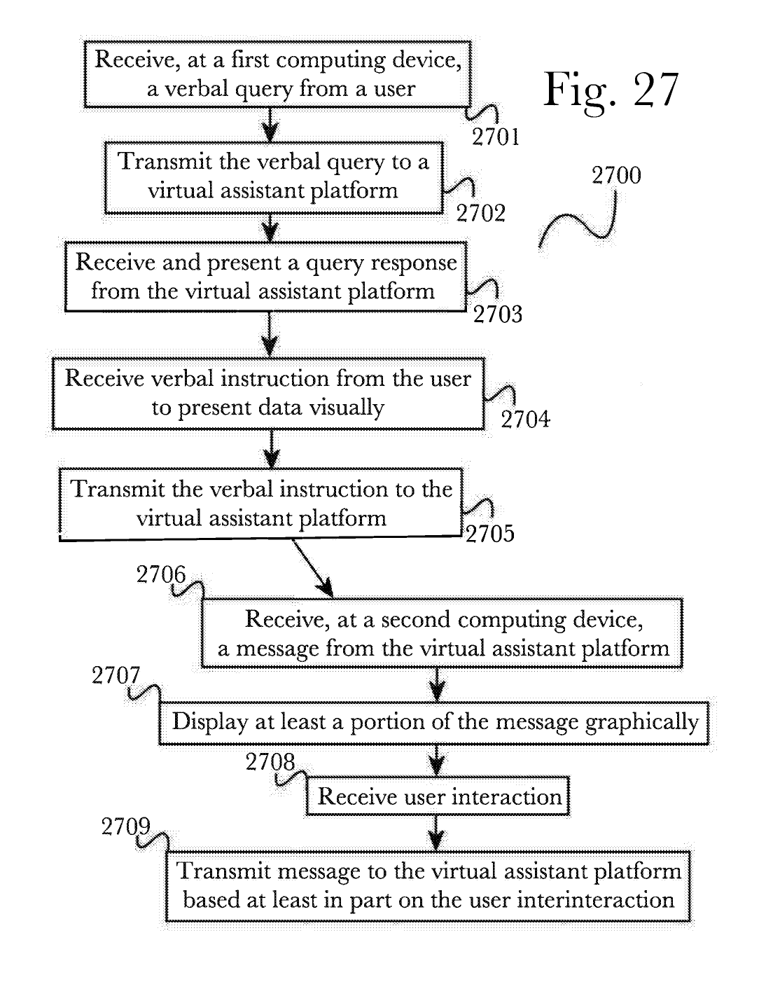

FIG. 27 is a flow diagram illustrating an exemplary method 2700 for providing real-time multidevice messages to a user, according to a preferred embodiment of the invention. In an initial step 2701, a first computing device comprising a memory, a processor, an audio input component, an audio output component, a wireless network interface, and a plurality of programming instructions operating in the memory and on the processor, may receive a verbal query from a user via the audio input component. In a next step 2702 the first computing device may transmit, using the wireless network interface, the verbal query to a virtual assistant platform via a network. In a next step 2703, the first computing device may receive a query response from the virtual assistant platform and present it to the user via the audio output component. In a next step 2704, the first computing device may then receive a verbal instruction from the user to present the information of the query response visually (rather than via audio), and in a next step 2705 the first computing device may transmit this verbal instruction to the virtual assistant platform.

In a next step 2706, a second computing device comprising a memory, a processor, a display, an input means, a network interface, and a plurality of programming instructions operating in the memory and on the processor may receive a data message from the virtual assistant platform via the network interface. In a next step 2707, the second computing device may present at least a portion of the data message graphically, using the display. In a next step 2708, the second computing device may receive a user interaction event from the user via the input means (for example, a keyboard, mouse, or touchscreen interface), and in a final step 2709 may transmit a message back to the virtual assistant platform based at least in part on the user interaction event.

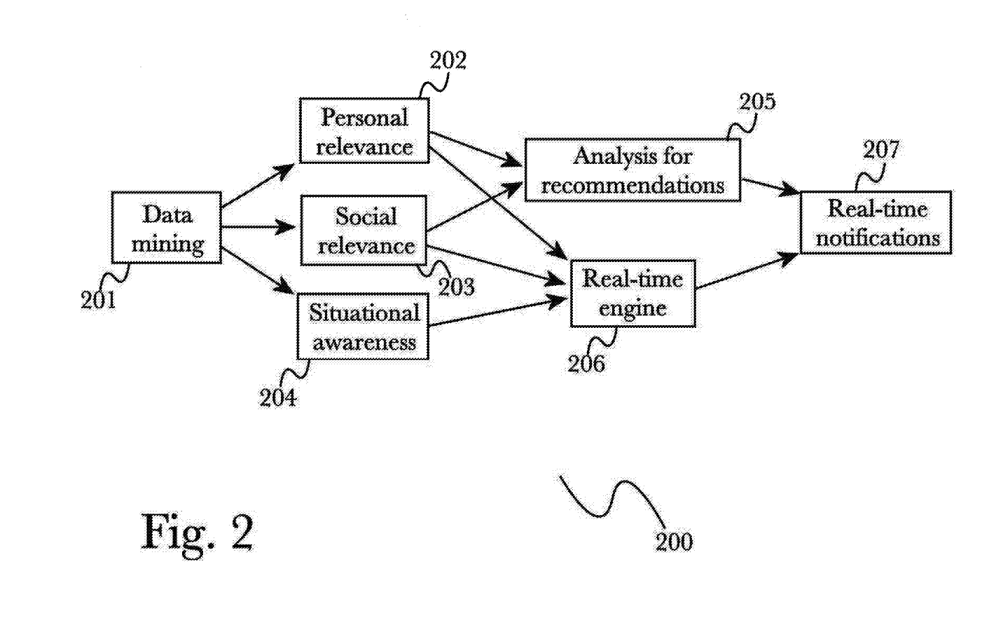

FIG. 2 is a flow diagram illustrating an exemplary overview method 200 for operating a virtual assistant platform with deep analytics and proactive interaction, according to a preferred embodiment of the invention. According to the embodiment, a data collector 112 may collect a variety of data from external sources in a data mining operation 201. Mined data may then be provided to an analysis engine 114 to be analyzed for personal relevance 202 such as connections between user accounts (for example, if new information from a social media posting refers to a company the user has invested in), social relevance 203 such as connections with external social information (for example, public news or social media postings) or with other users (such as a user's friends, colleagues, or family), and for situational awareness 204 such as known current events or historical trends. Observed data correlations may be used to generate recommendations 205 based on data relationships, and may be handled by analysis engine 114 in real-time 206 so that recommendations are produced while they are most relevant—that is, immediately upon discovering changes in data or interactions between relevant data, and with real-time situational awareness providing information context. Real-time notifications 207 may then be produced for presentation to the user, such as suggested actions to take in response to observed or predicated changes, alerts based on changes to a user's relevant data (such as fluctuations in stock prices, or life events in social network postings for relevant users such as family), or other notification types.

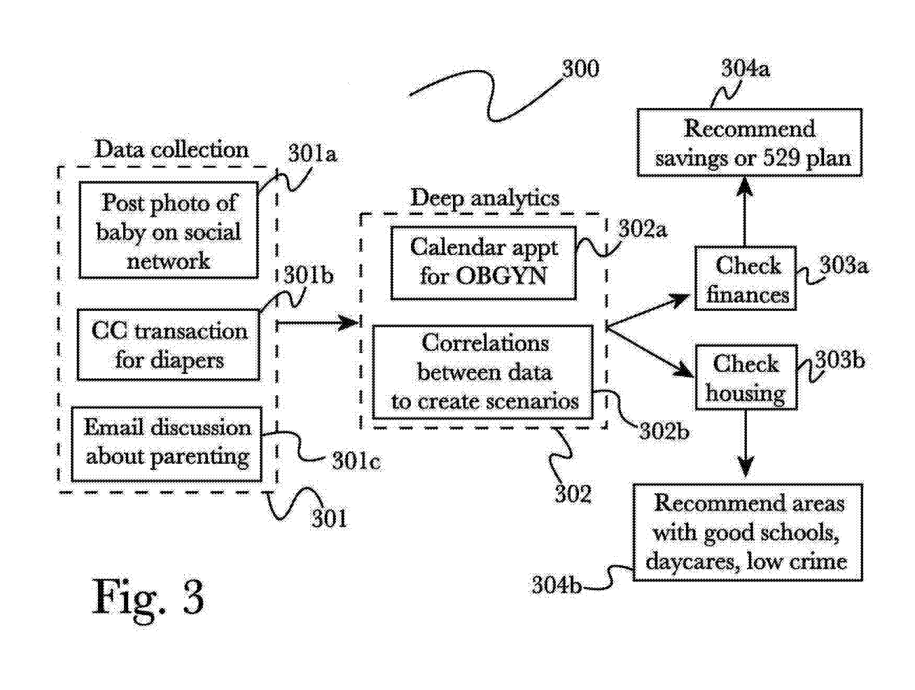

FIG. 3 is a flow diagram illustrating an exemplary method 300 for operating a virtual assistant platform with deep analytics and proactive interaction, illustrating an exemplary use case of deep analytics insights to generate personalized notifications for a user. According to the embodiment, data collection 301 may receive a variety of information inputs from different sources such as a social media posting 301a where a user uploaded a photograph of a newborn baby, a credit card transaction showing the user purchasing diapers 301b, and an email conversation discussing parenting 301c. This information may then be processed using deep analytics 302 by an analysis engine 114 to find additional relevant data such as a scheduled OBGYN appointment 302a, and to reveal data correlations 302b and create a data “scenario” that connects the information to form a larger view of the events occurring behind these discrete data points. This scenario may then be used to cross-examine with other information, for example checking a user's finances 303a to check the state of their savings or investments, or to see whether they have any financial preparation plans established. Another example may be to check a user's housing situation 303b, to see how their current living arrangements compare against metrics like crime rates or quality of nearby education for their new child. This additional information may then be used to produce specific recommendations and provide them for review by the user, such as prompting the user to review their budgeting goals 304a to revise them for new expenses involved with having a new child or to begin a 529 plan or other preparatory plan to save for future expenses, or to recommend housing changes such as suggesting alternative housing 304b that fits the user's current or proposed budget (for example, after considering savings for child expenses) that may be near better schools, have a number of daycares nearby, or have low crime rates.

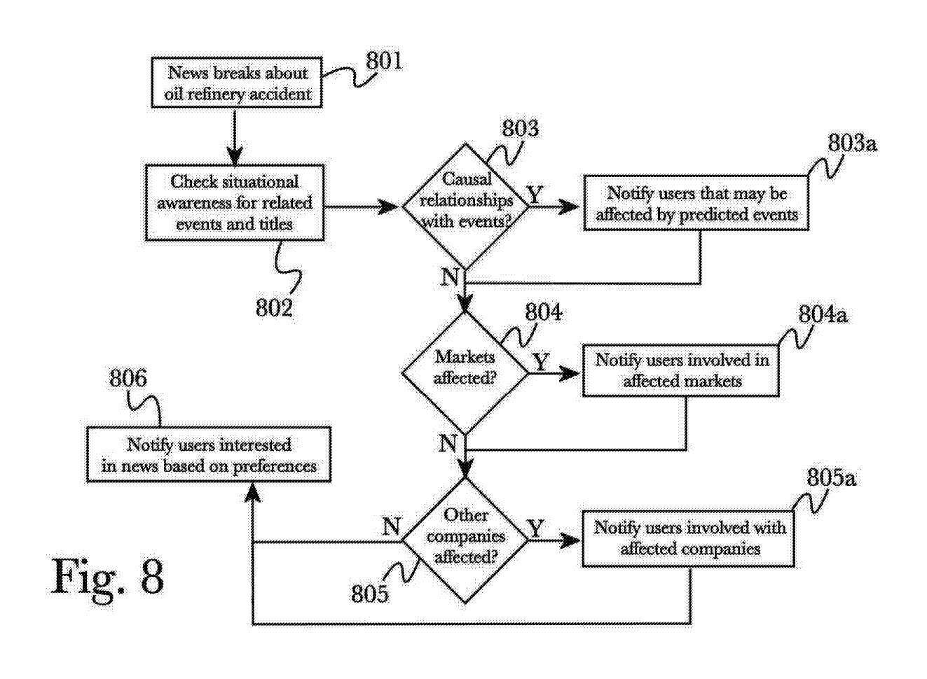

FIG. 8 is a flow diagram illustrating the use of a virtual assistant with deep analytics and proactive interaction for predicting and managing the impact of a global event, illustrating processing of an oil refinery accident and its impact on markets and users. In an initial step 801, a news outlet may report on an event such as an oil refinery accident or other event with potentially far-reaching effects. In a next step 802, analysis engine 114 may analyze available information for situational awareness 204, for example to check for related news events (such as a conflict in the region of the oil refinery), financial information (such as companies involved with this oil refinery and events relating to them such as recent or upcoming mergers), or other relevant information title entities (as described previously, referring to FIG. 1).

This situational awareness may then be used to perform a variety of analysis examinations of available data to determine who or what may be affected by this event 801, and to determine how to respond. Analysis engine 114 may check to determine whether any events are predicted to have a causal relationship with the initial event 803, for example analyzing potential contributing factors or events that may be triggered such as increased local unemployment while the refinery is repaired or abandoned, and may notify users 803a that would be affected by these predicted events or that may already be affected by related contributing events without realizing it.

Analysis engine 114 may then examine financial markets to determine what changes have occurred or are predicted to occur resulting from this event 804, such as changes in the value of crude oil or in the stock value of the company that owns the oil refinery. Users affected by these market changes may be notified 804a and optionally provided with suggested actions to take, such as to sell stock in one company and buy in another to take advantage of the market reaction to the event.

Analysis engine 114 may then check to see if other companies may be affected by the event 805 such as partners or competitors of the company owning the oil refinery, and may notify users involved with those companies to proactively bring their attention to the potential changes due to this event and optionally offer suggested actions to take. For example, a user may own stock in a nearby transportation company that has a contract to transport crude oil into the refinery, that may decrease in value now that the refinery is not operating. The user may then be prompted to sell this stock before the market reflects this change, to minimize their losses due to the event.

When all situational processing is complete, users that may be interested in this event may be notified 806, such as users who have specified a preference for following news pertaining to the local region where the oil refinery is located, or who are interested in news related to energy or resources. For example, a user may not be affected by an event but may still wish to follow it for various reasons, and they may be notified of the event based on their preference for being kept informed despite the fact that they are unaffected. Another user may potentially be affected, but has not made their information available for analysis (this may be referred to as a “lurker”), instead choosing to stay informed of news events so they can manually decide how to respond.

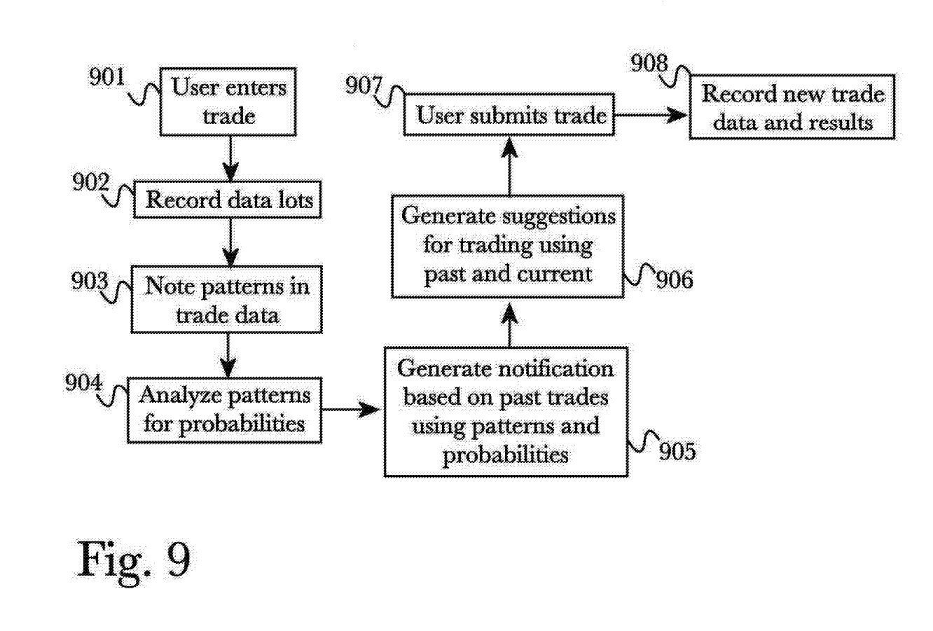

FIG. 9 is a flow diagram illustrating the use of a virtual assistant with deep analytics and proactive interaction for assisting a user with a financial trade, illustrating the use of historical analysis and proactive notification to provide the user with a recommendation. In an initial step 901, a user enters a trade they wish to perform. The data for this trade is then recorded as data lots 902 to be stored for future reference, such as the specific stocks or commodities being traded, amounts, values, and other trade-related information. Analysis engine 114 may then identify patterns in trade data 903 such as trends in market value or user behavioral tendencies, such as if a user tends to invest in similar types of commodity or tends to sell in response to certain types of events. These patterns may then be analyzed 904 to determine various probability statistics, such as to extrapolate the likelihood that a user will take a particular action under specific circumstances, or the probabilities for various trade outcomes based on known patterns and historical data. A notification may then be generated for presentation to the user 905, based on past trades and other historical data and analysis insights such as patterns and probabilities related to the trade. This notification may then be provided to the user 906 with a plurality of proactive suggestions to help the user improve their trade, by incorporating analysis insights based on historical performance and predictions based on patterns and probabilities to improve the outcome of the user's trade. The user may then choose to modify their trade in light of the suggestions received, or simply to submit as-is 907, at which point the trade data and results are recorded for future reference 908 and use in further analysis for future trades.

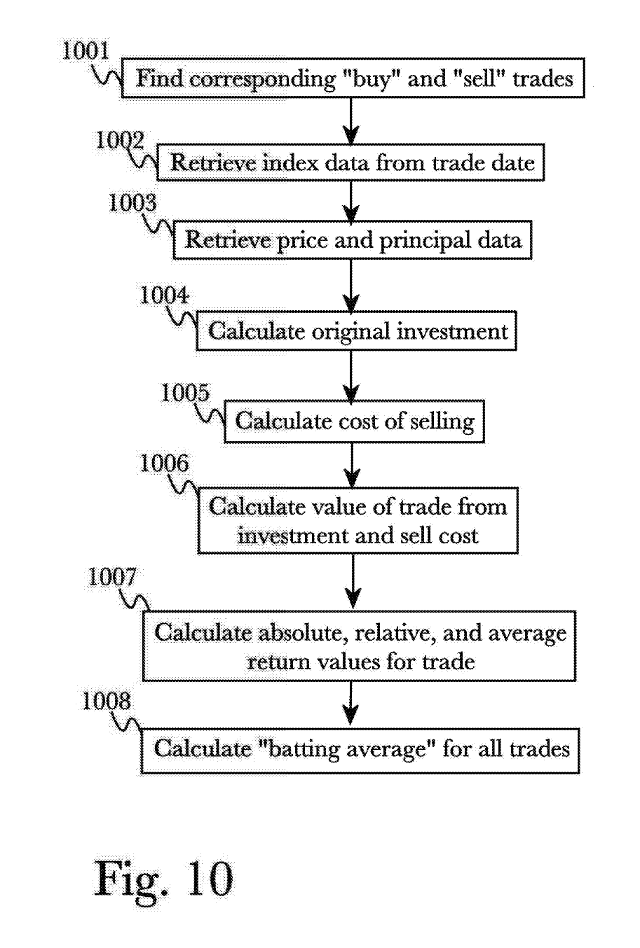

FIG. 10 is a flow diagram illustrating the use of a “batting average” algorithm to assist users with financial decisions. According to the embodiment, a user's performance (described as “batting average” and “slugging %”) may be calculated based on a variety of information that may be collected and calculated to accurately represent a user's trading performance. In an initial step 1001, analysis engine 114 may find the corresponding “buy” and “sell” trades for a user. This may take into account a variety of possible situations, such as: the user bought one package and sold that same whole package; the user bought one package and sold it divided into parts; the user bought one package, then another package, and sold the packages together, or the user bought one package and sold a portion of it, then bought another package and sold the combined new package and remaining portion of the first package. In a next step 1002, analysis engine 114 may download data about SPY index at the date of trade, and may then calculate the percent of change for the index, for example as (SPY at the clay of selling−SPY at the day of buying)/SPY at the day of buying). Next, price and principal data may be retrieved 1003 for use in calculations.

In a next step 1004, analysis engine 114 may calculate original investment (cost of buying), looking at the operation of corresponding buying for this package. For example:

Cbᵢ=Qᵢ*Pb
For trade on 7.24.2013:
Cb1=4000 (Quantity)*0.5(Price of buying)=2000

This corresponds to the cost of buying for asset (original investment; how much did the user pay when they bought a package); below is an exemplary calculation for the cost of selling for asset 1005. Information may be retrieved from the web about SPY index: it is necessary to find out the % of change for SPY index between date of buying trade and selling trade.

The Cost of Selling:

Csᵢ=Qᵢ*P_{S}_{ᵢ}=Principalᵢ
For trade on 7.24.2013:
   Cs1=4000 (Quantity)*0.8 (Price of selling)=3200 (! That's Principal)

Cost of selling may be calculated 1005 and corresponds to the amount that a user is selling, multiplied by price of selling. It should be equal to Principal, so it is possible to just take the meaning of Principal.

Dollar Value of a Trade:

Vᵢ=Principalᵢ−Cbᵢ
For trade on 7.24.2013:
   V1=3200−2000=1200

Next the overall “value” of a trade may be calculated 1006. Dollar value corresponds to the difference between how much the user gains from a trade and how much they paid for the trade.

Next, the absolute, relative, and average return values may be calculated 1007, for example using calculation algorithms below.

The absolute return for Qi (each trade of selling):

$${AR}_{i}^{′} = \frac{{Principal}_{i} - {Cb}_{i}}{{Cb}_{i}}$$

$$AR 1 = 1200 / 2000 = 0 , 6$$

Efficiency of each trade (percent):

Eᵢ=ARᵢ*100%
E1=60%

Relative return (comparing to S&P 500, SPY in this case):

RRᵢ=Eᵢ−SPYᵢ
RR1=60%−0.339387%=59.66061%

Average Absolute Return:

$${\overline{AR}}_{TQ} = \frac{{\sum }_{i = 1}^{n} {AR}_{i}}{n}$$

Optional auxiliary computations may include:
If RRᵢ>=0 then:
Fᵢ=1 (the “flag”) and N_{w}=N_{w}+1
Nw—number of “winning” trades.

Otherwise (RRᵢ<0):
Fᵢ=0 and N_{L}=N_{L}+1
NL—number of “loosing” trades.

For example:
For the trade on 7.24.2013:
   RR>0=>F1=1. Nw+1. N1+0 (that's the “winning” trade)

These statistics may then be used to compute the batting average 1008 for a user, to indicate their trading performance for use in forming predications and recommendations for current and future trades.

Batting Average:

$$BA = \frac{{N}_{w}}{{N}_{L}}$$

For all trades where Fi=1 (that indicates a “winning trade”):

$${\overline{V}}_{M} = \frac{{\sum }_{j = 1}^{Nw} {V}_{j}}{{N}_{w}}$$

This summarizes the amount of money (dollar value of a trade) for all the winning trades and divide it by the number of winning trades.

For all trades where Fi=0 (that indicates a “losing trade”)::

$${\overline{V}}_{L} = \frac{{\sum }_{j = 1}^{Nl} {V}_{j}}{{N}_{l}}$$

Slugging Percentage:

$$SP = \frac{{\overline{V}}_{w}}{{\overline{V}}_{l}}$$

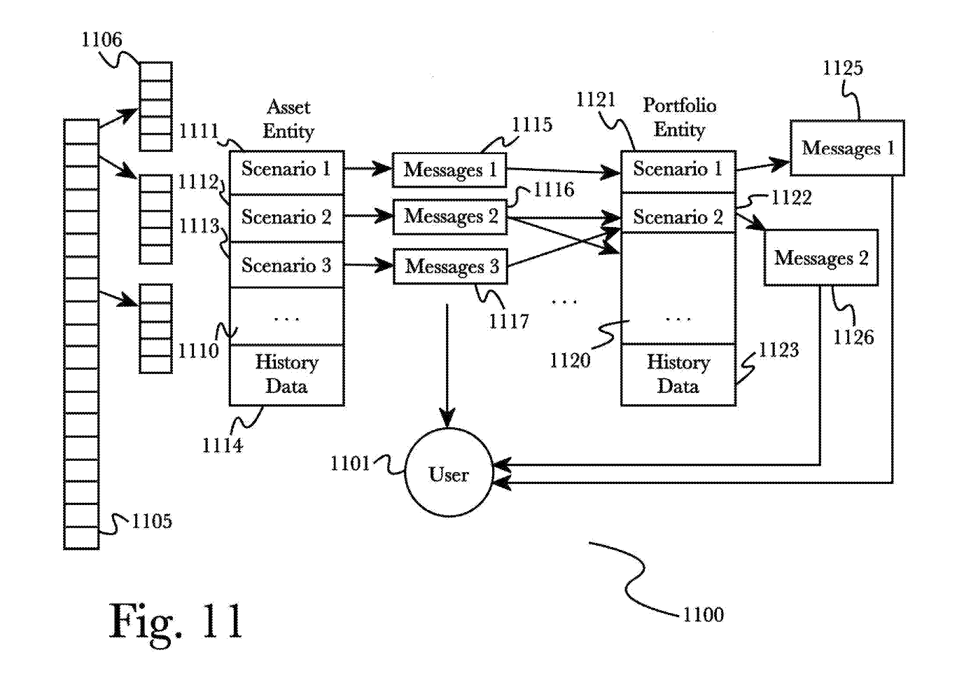

FIG. 11 is a process diagram 1100 showing how user notifications are generated from events regarding assets, according to an embodiment of the invention. According to the embodiment, portions status vectors 1105 are sent as partial status vectors 1106 to an asset entity 1110, which may be for example a software module configured to receive messages comprising partial status vectors 1106 and to apply rules in handling those messages. Asset entity 1110 may comprise a plurality of scenarios, such as scenario 1 1111, scenario 2 1112, and scenario 3 1113, as well as historical data 1114 pertaining to an underlying asset represented by asset entity 1110 (e.g., a stock/equity asset or a bond asset). As partial status vectors 1106 arrive at asset entity 1110, they are evaluated against one or more scenarios 1111-1113, possibly using historical data 1114 as well, and when appropriate scenario-generated messages may be sent (e.g., message 1 1115, message 2 1116, message 3 1117, and the like). These messages may in turn be sent directly to a user 1101, and may also be sent to one or more portfolio entities 1120. Like asset entity 1110, portfolio entity 1120 may comprise one or more scenarios 1121, 1122 and historical data 1123. Portfolio entity 1120, on receiving messages 1115-1117, evaluates the messages according to one or more scenarios 1121, 1122 and potentially generates messages 1125, 1126, which are sent to user 1101. In this way, as events occur regarding various assets, the corresponding asset status vectors 1105 may be modified, and portions of these vectors may be sent (as partial status vectors 1106) to asset entities 1110 for processing, thereby potentially generating asset-level and portfolio-level messages that are sent to user 1101 as a result of the underlying asset events.

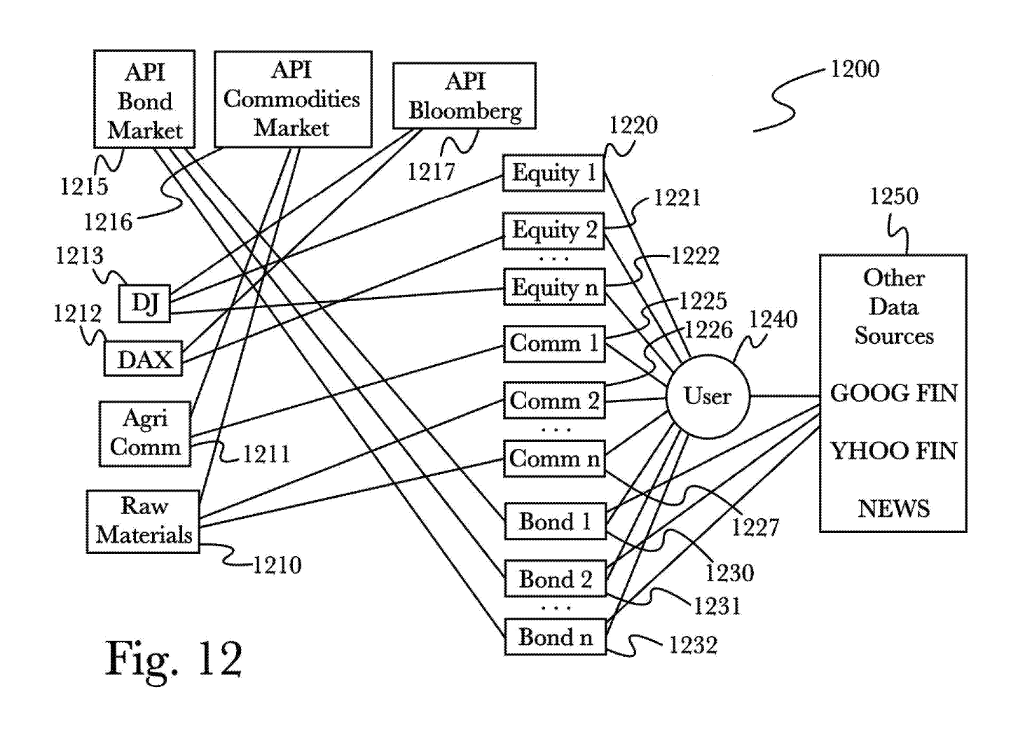

FIG. 12 is a data flow diagram 1200 showing various data sources and objects in relation to users, according to an embodiment of the invention. According to the embodiment, software APIs may be used to connect to data sources such as bond markets 1215, commodities markets 1216, or Bloomberg 1217 or similar financial data or media sources, and may connect specific asset types such as the Dow Jones 1213 or other financial news or publishing firm, the DAX 1212 or other stock market index, or a variety of commodities such as (for example) agricultural commodities 1211 such as wheat or tobacco, or raw materials 1210 such as metals or oil. An API for a particular data source may be configured to receive information from the data source in its native format (that is, as it is naturally stored and provided by that source) and provide any necessary translations or transformations to accommodate the information and integrate it with other data and systems, such as data from other APIs so that information may be stored, tracked, and viewed in a consistent manner. Within a plurality of data sources and asset types, there may be a number of specific assets relevant to a user 1240 such as a user's equities 1220-1222, commodities 1225-1227, and bonds 1230-1232. Additional information may be collected from other data sources 1250 such as financial indices and news sources, optionally with or without the use of a specific API as needed (for example, news article information may be publicly available and presented in plaintext, facilitating ease of collection and integration without the use of specially-written software).

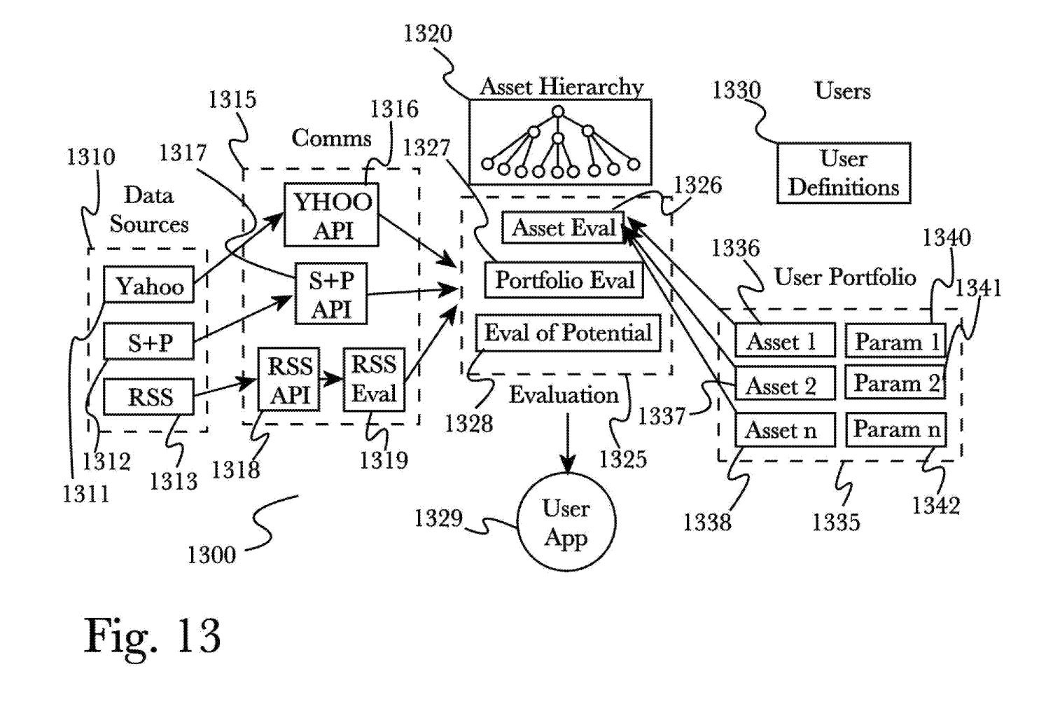

FIG. 13 is a process and data flow diagram 1300 showing sequential flow of data and actions leading to user notification, according to an embodiment of the invention. According to the embodiment, a plurality of data sources 1310 such as (for example) YAHOO™ 1311, Standard & Poor's Financial Services 1312, or RSS feed data 1313 may be collected via a variety of communication adapters 1315 such as APIs for data sources 1316-1318, or an RSS evaluator 1319 that may be used to selectively identify relevant information and process it for use (for example, stripping irrelevant content and identifying associated data. Collected data may also comprise an asset hierarchy 1320 describing an organized structure for storing and processing asset-related information, for example an asset type (such as stocks) may be near the “head” of a hierarchical structure, with specific sources (such as specific traded corporations on the stock index) underneath, each branching out into specific assets (specific stocks for the corporations). Collected data may then be evaluated 1325, incorporated asset evaluation 1326 for a specific user portfolio 1335 by collecting and evaluating the user's owned assets 1336-1338 and parameters for their assets 1340-1342 such as quantity, date acquired, and other information values that may be associated with a particular asset. Portfolio evaluation 1327 may consider a user's portfolio 1335 as well as known information from data sources and an asset hierarchy 1320, and an evaluation of potential 1328 may identify various potential values relevant to the portfolio (such as identifying trends or likely events that may affect a user's portfolio, or that they may wish to act upon preemptively). Evaluation results may then be sent to a user application 1329 for review. User definitions 1330 may be any number of information values associated with the user, such as demographic information and other user-specific or identifying information.

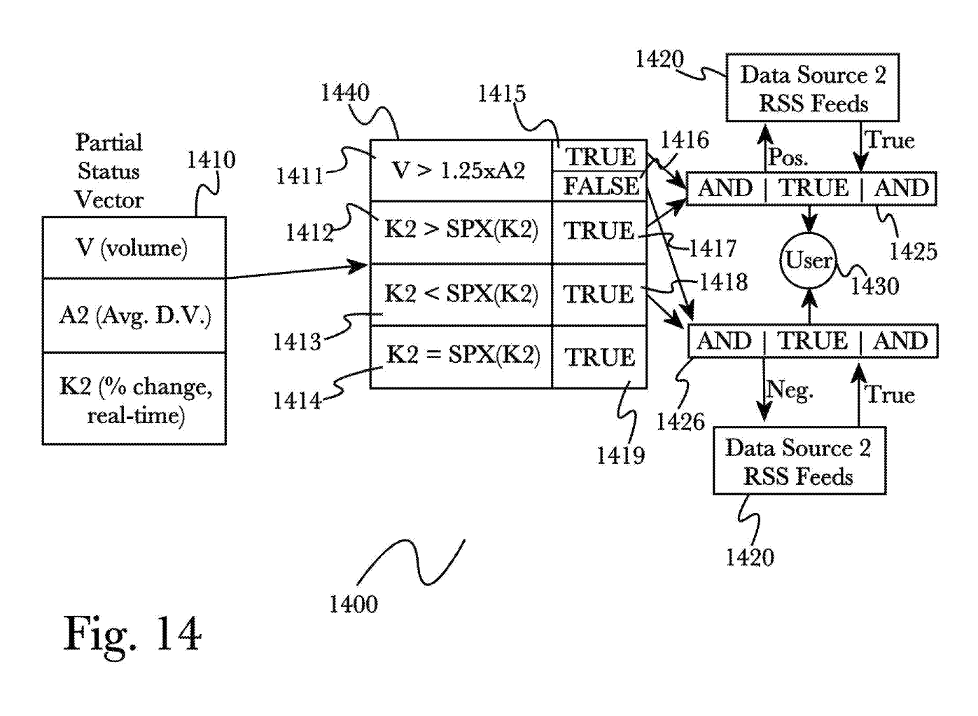

FIG. 14 is a diagram illustrating an exemplary process flow diagram 1400 showing how partial status vectors lead to user notifications, according to an embodiment of the invention. According to the embodiment, a partial status vector 1410 may comprise a number of specific status values such as volume, average daily variance, or real-time change. These values may be analyzed 1440 to determine appropriate actions to take, such as checking whether volume is greater than a configured threshold for daily variance 1411 and returning true 1415 or false 1416, or whether it is true 1417-1419 that the real-time daily change is greater than 1412, less than 1413, or equal to 1414 the overall change of an index (indicating how this particular asset is performing relative to the market overall). Analysis may then drive user notifications, for example if a volume returns “true” 1415 when checked against the average daily variance, then a notification rule may trigger as “true” 1425, notifying a user 1430 accordingly. However, if the same analysis returns “false” 1416, a different notification rule 1426 may trigger, and additionally any notification rule may check against data sources such as RSS feeds 1420, for example to verify whether a change is being discussed or presented as positive or negative.

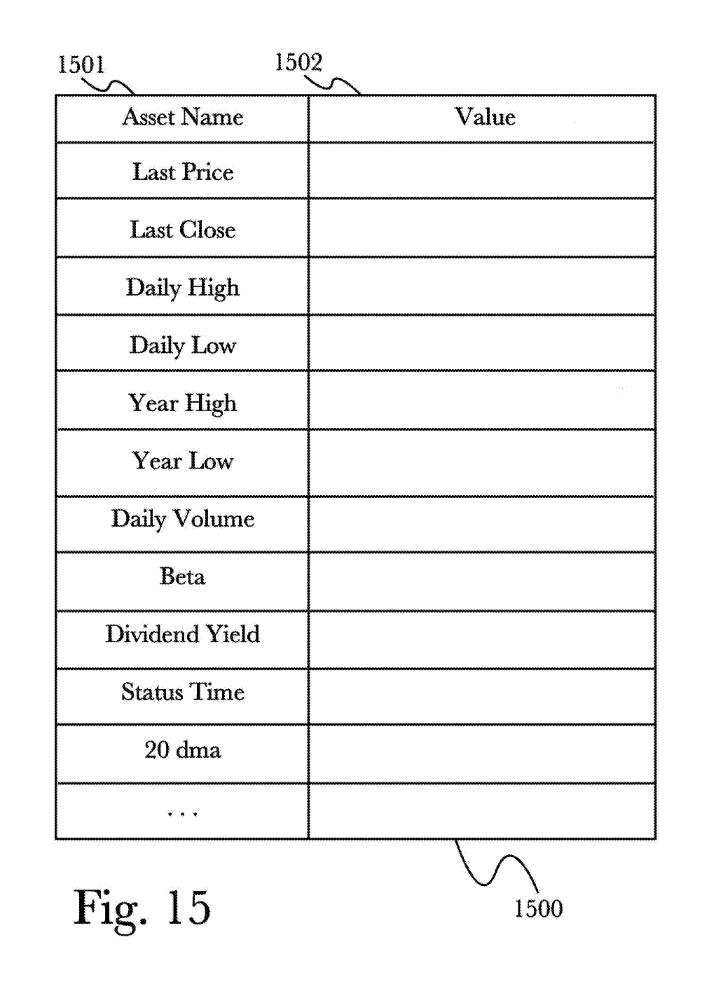

FIG. 15 is a table showing a typical status vector 1500, according to an embodiment of the invention. According to the embodiment, a status vector 1500 may comprise any number of data types 1501 and values 1502 for an asset, such as (for example) the last price the asset traded at, the last price the asset was trading at when the market closed, the current daily or yearly high and low price values, daily trade volume, current beta (indicating volatility relative to the market as a whole), dividend yield, the status timestamp of the last update, or direct market access values.

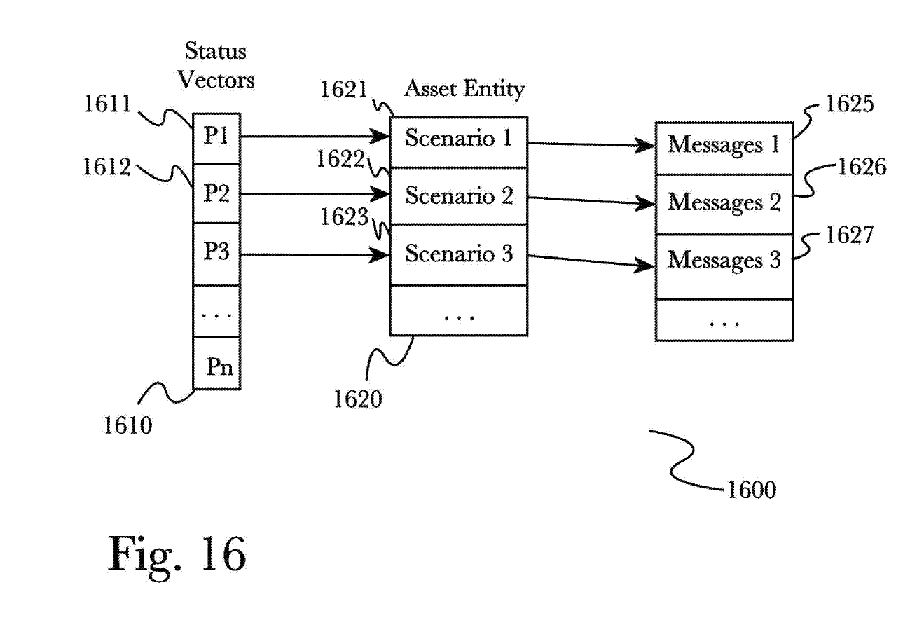

FIG. 16 is a diagram showing communication flow from status vectors 1610 to user messages 1625-1627, according to an embodiment of the invention. According to the embodiment, a plurality of status vectors 1610 comprising portfolio data 1611-1612 may be analyzed for information on asset entities within those portfolios 1620 and processed according to a plurality of scenarios 1621-1623, generating messages 1625-1627 based on the outcome of analysis (as described previously in greater detail, referring to FIG. 11 and FIG. 14, above).

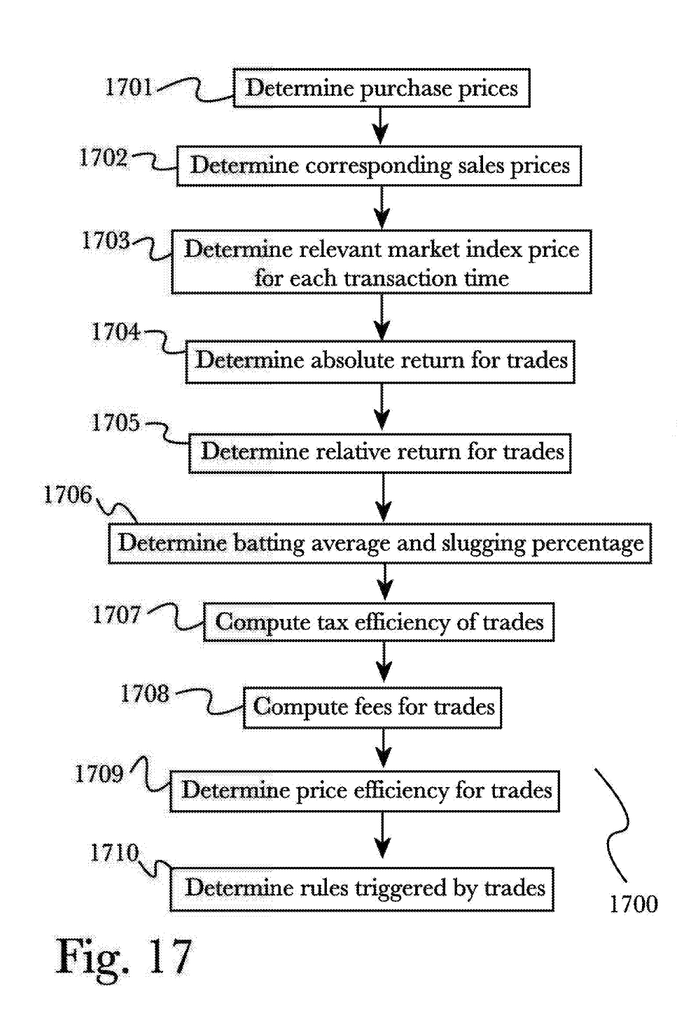

FIG. 17 is a method diagram for computing batting averages and triggering rules by trading activity of a user, according to an embodiment of the invention. In an initial step 1701 of method 1700, a plurality of purchase prices for a user's previous trades are determined. In a next step 1702, the corresponding sales prices may be determined for these trades. In a next step 1703, the relevant market index price may be determined for each transaction time for these historical trades. In next steps 1704-1705, the absolute and relative return values may be determined for trades, and in a next step 1706, determined values may be utilized to compute a user's batting average and slugging percentage across these historical trades. In a next step 1707, the tax efficiency of trades may be computed, and in a next step 1708, any fees for trades may be computed. In a next step 1709, the price efficiency may be determined, and in a final step 1710 any rules triggered by these trades may be determined.

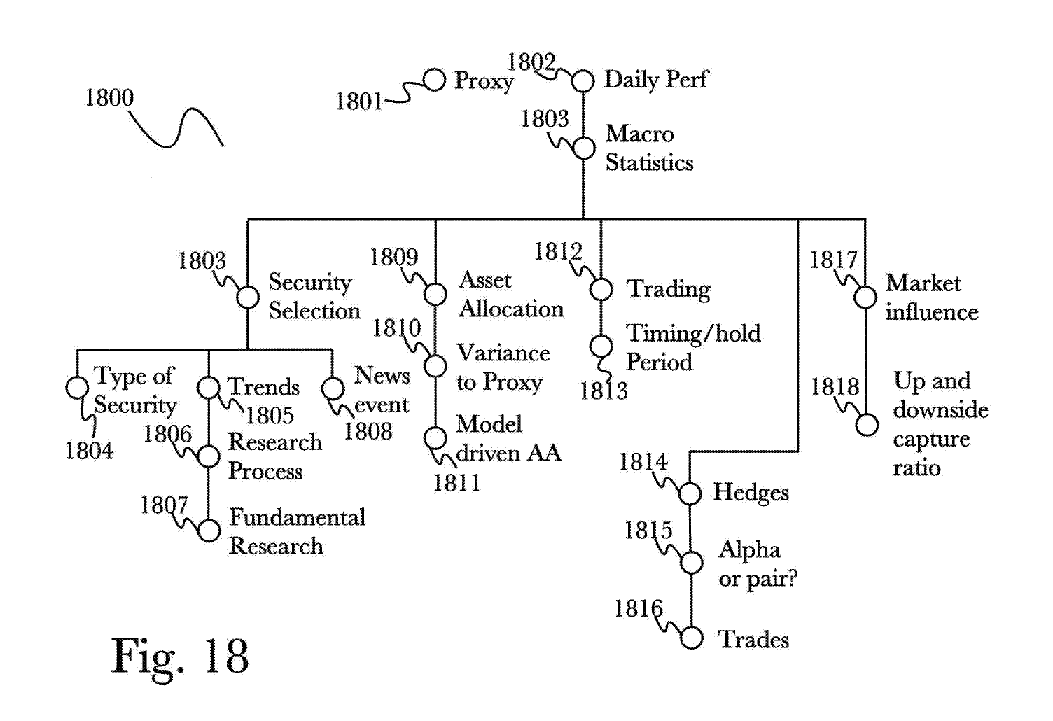

FIG. 18 shows a hierarchical data arrangement 1800, according to an embodiment of the invention. According to the embodiment, a market proxy 1801 may be utilized to act as a representative for another market entity, for example if a commodity is not represented on an index but a company who produces the commodity is. A daily performance value 1802 may comprise a macro statistics 1803 value, which in turn comprises a plurality of information values organized into a hierarchical structure as illustrated. A security selection 1803 pertains to information on a given security, such as (for example, including but not limited to) the type 1804 of security, any known or identified trends 1805, or news events 1808 pertaining to the security. Trends may be identified from a research process 1806 and fundamental market research 1807. Asset allocation 1809 may comprise a model-driven asset allocation 1811 process that utilizes a structured asset hierarchy to analyze asset information, and variance to the proxy 1810 (if one is used) to determine how an asset if performing. Information may be stored on trades 1812 and trade timing or holding periods 1813, and data collected on hedges 1814 comprising related trade data 1816 and whether it is an alpha- or pair-trade 1815. Additionally, market influence data 1817 may be collected, including upside and downside capture ratios 1818.

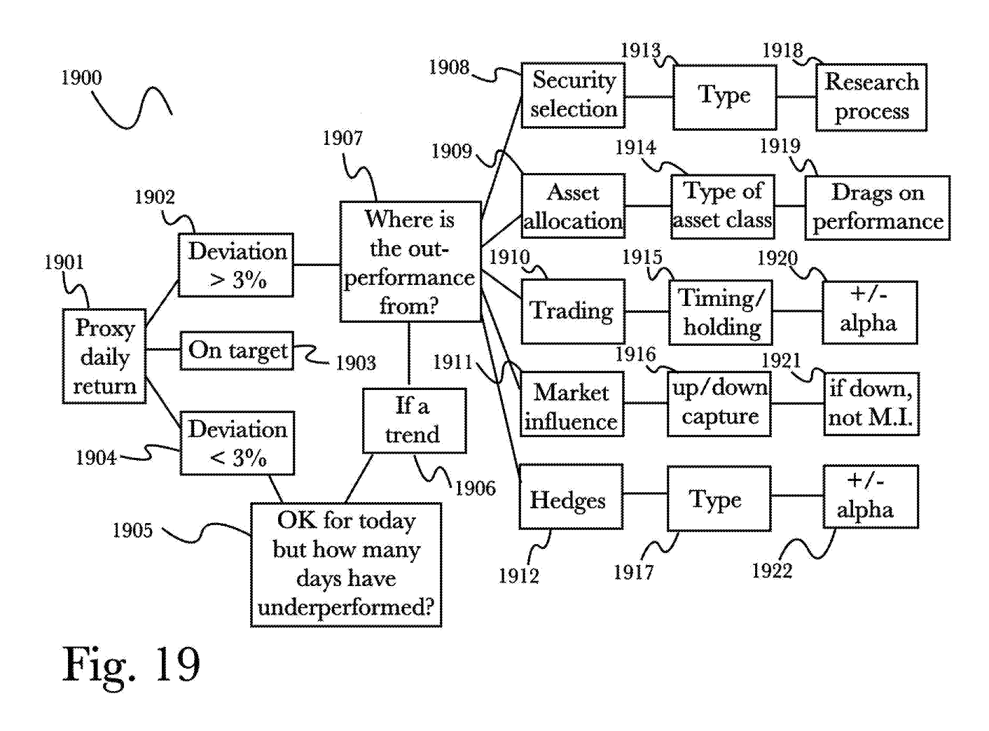

FIG. 19 is an exemplary decision tree 1900, according to an embodiment of the invention. According to the embodiment, the daily return for a proxy 1901 may be checked to determine whether it is currently on-target 1903, or if it is over 1902 or under-performing 1904. If it is not on-target, the historical data may be checked 1905 to determine how long it has been over or under-performing (under-performing only shown for simplicity and clarity), and this information may be used to determine if the performance is indicative of a trend 1906. Then, the disparity in performance may be analyzed 1907 to determine the cause, by examining the proxy information hierarchy (as described above, referring to FIG. 18) to identify influencing factors in performance. Security selection 1908 may be checked for security type 1913 and research 1918, asset allocation 1909 may be checked for asset type 1914 and any possible drags on asset performance 1919, trading performance 1910 may be checked for timing or holding periods 1915 and alpha information 1920, market influence 1911 may be checked for upside or downside capture information 1916 (and if downside, then it can be determined that any performance is not due to market influence 1921), and hedges 1912 may be checked for type 1917 and alpha 1922 information.

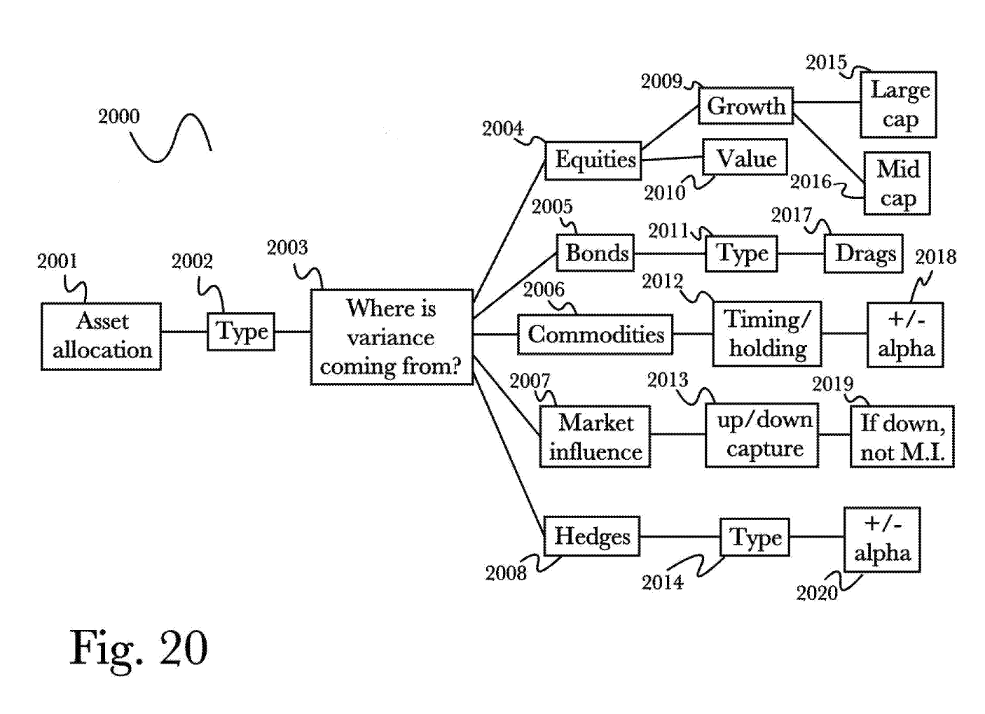

FIG. 20 is an exemplary decision tree 2000, according to an embodiment of the invention. According to the embodiment, asset allocation 2001 may be examined for asset type 2002 and then to determine where any determined variance is coming from 2003. Equities 2004 may be checked for their value 2010 and growth 2009, as well as their growth potential (for example, whether they are large 2015 or mid 2016 growth equities, or other growth capital types). Bonds 2005 may be checked for their type 2011 and potential performance drags 2017, and commodities 2006 may be checked for timing and holding data 2012 as well as alpha data 2018. Market influence 2007 may be checked for upside or downside capture information 2013 (and if downside, then it can be determined that any performance is not due to market influence 2019), and hedges 2008 may be checked for type 2014 and alpha 2020 information.

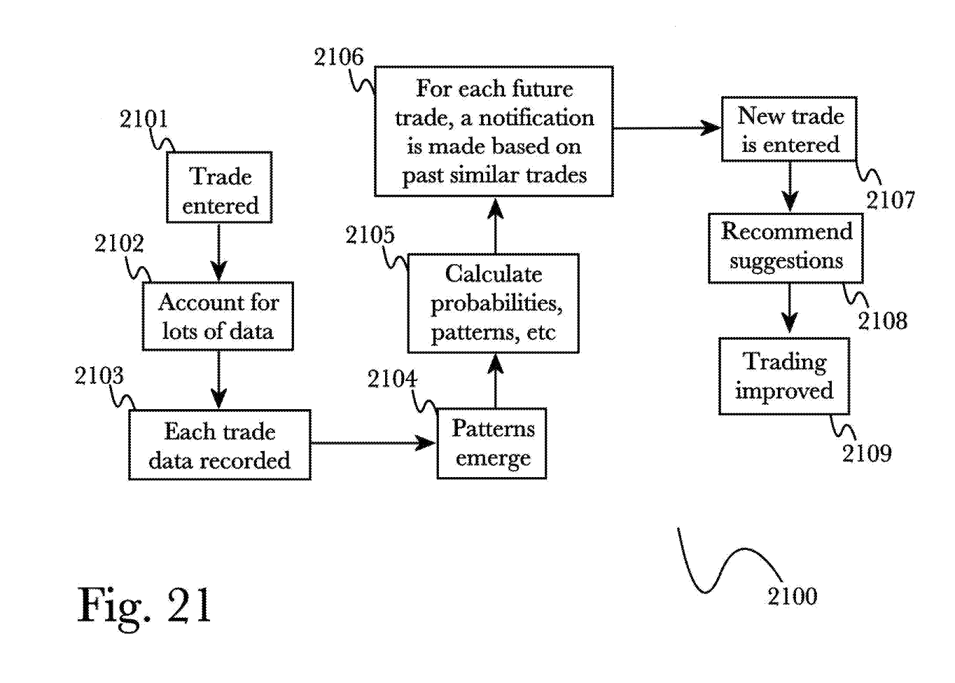

FIG. 21 an exemplary decision tree 2100, according to an embodiment of the invention. According to the embodiment, when a user enters a trade 2101, data lots may be collected 2102 for the trade and recorded 2103, and may then be analyzed to identify patterns 2104. From this analysis, patterns and probabilities may be determined 2105 and used for future trades 2106 to notify a user based on their trade history and performance. The user may then enter a new trade 2107, which may optionally be the same trade (if they do not wish to alter their trade after reviewing performance data), and view any suggestions based on the new trade 2108, resulting in improved trading 2109 through the use of analysis and live suggestions for improving performance based on past data and analysis results.

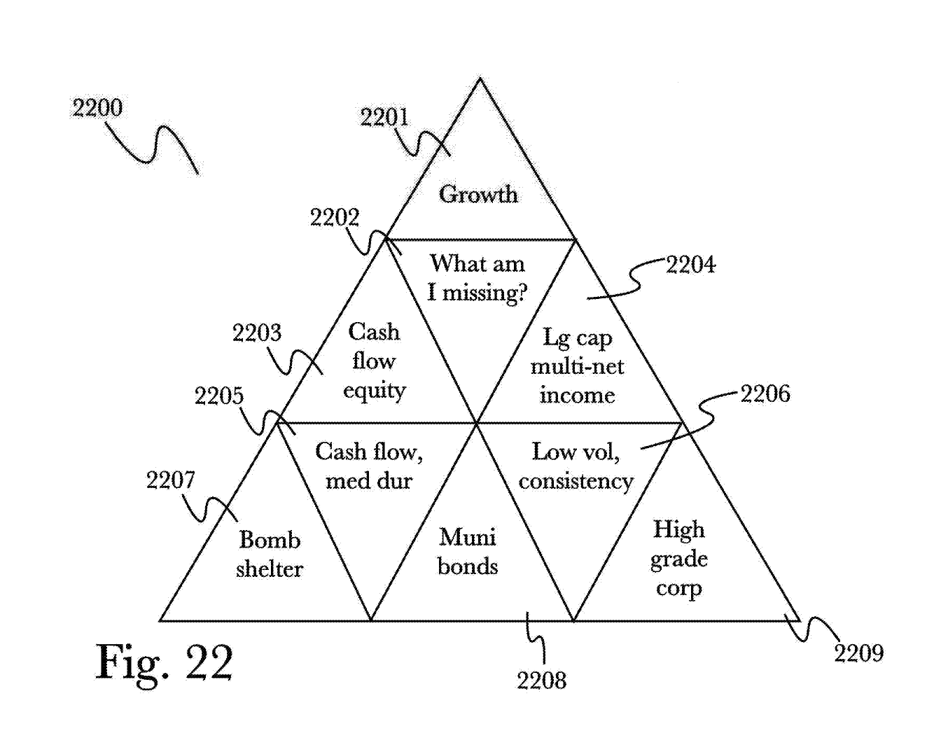

FIG. 22 is a conceptual diagram 2200 showing different asset classes and goals, according to an embodiment of the invention. According to the embodiment, financial growth 2201 may be derived from a hierarchy of contributing factors, from low-risk secure investments (such as, for example, physical investments like a bomb shelter 2207, low-risk municipal bonds 2208 or high-grade corporate investments 2209), the focus on low volume and consistency 2206 for medium-duration cash flow 2205, to large-capital multi-net income investments 2204 focusing on cash flow equity 2203, and analysis to identify missing elements 2202 to encourage growth through intelligent analysis and user notification to improve performance.

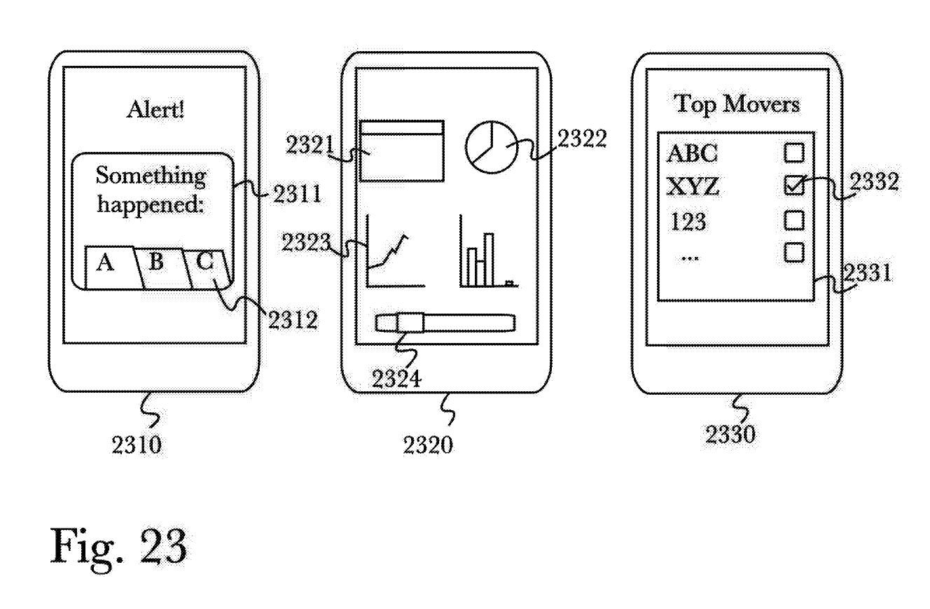

FIG. 23 is an illustration of an exemplary user interface for a virtual assistant application, illustrating an exemplary proactive notification display and a user portfolio management interface, according to a preferred embodiment of the invention. In a notification display 2310, a notification may be presented to a user as a popup within an application, or a push notification to their mobile device, or similar notification functionality according to their device capabilities or preferences. A notification may present the user with a brief summary of an event 2311, such as an alert about an event that may affect them, or a suggestion based on deep analysis, and may present a user with a plurality of interactive indicia 2312 to view additional information, such as displaying folder tabs corresponding to related information for the notification. For example, in a notification offering a finance suggestion such as a way to improve a trade, a user may be shown indicia to view their portfolio information 2320, or to view market information 2330, so that they may review the information before deciding how to respond to the notification.

In a portfolio view 2320, a user may view various information related to their financial analysis that may be used to produce notifications and offer suggestions. A calendar 2321 may show events the user should be aware of, such as earnings dates, macro events, political events, or other such events that may affect their portfolio. A user may also view their portfolio allocation graphically 2322, as well as a plurality of graphical representations of portfolio performance against selected benchmarks 2323. A slider 2324 or other scalar element may be presented to allow a user to adjust the sensitivity for future alerts, for example to prevent unnecessary notifications over minor events or to increase sensitivity for alerts pertaining to specific elements of their portfolio.

In a market view 2330, a user may view market information pertaining to their portfolio or a particular trade, or information relevant to a particular notification such as market changes that were used in the analysis that led to the generation of an alert. A plurality of relevant stocks or commodities may be shown 2331, along with selection indicia 2332 for a user to select whether or not they wish to be notified of changes and events pertaining to a particular stock. For example, a user may wish to follow stocks in which they have not invested, to keep an eye on the market for future investment opportunities. To do this, a user may manually select stocks to follow for notifications even though they are not directly involved with those stocks (and thus would not be notified of changes as part of regular handling, as described above with reference to FIG. 8).

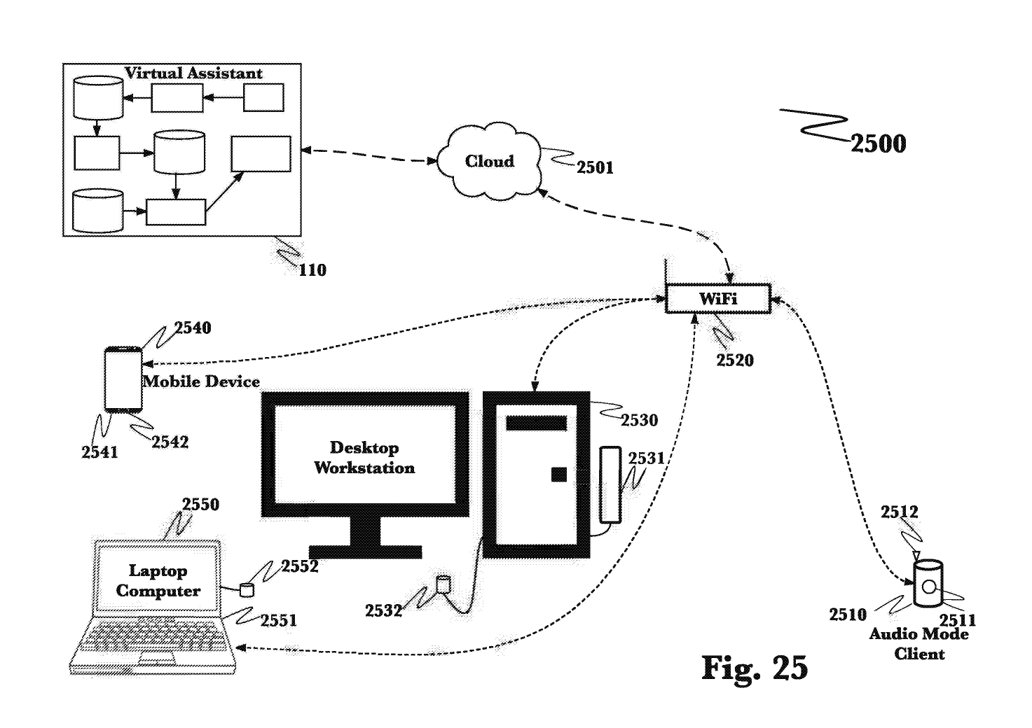

FIG. 25 is a diagram of an exemplary system architecture, illustrating the use of a mixed audio and visual interaction system for financial information notification and retrieval according to an embodiment of the invention. When so configured, the system may audibly announce some portion of a push message or notification in natural language 2500. In this situation, push message and notification or alert information may be sent from the virtual assistant across the internet or other data network in use 2501 to client internal networks 2520 and devices 2510, 2530, 2540, 2550. One or more of these devices, including a device specifically designed for audio type interaction, an “audio mode client” here 2510, may be configured to verbally announce some identifying portion of the notification or push message such as but not limited to a title; or all, or part of a summary as per previous client configuration. In some system configurations such audio mode clients 2510 may be placed at locations throughout a client's dwelling. Other configurations may also allow the client's desktop computers 2530, laptop computers 2550 and mobile devices such as, but not limited, to smart phones and tablets 2540 to make natural language announcements with audio announcements being controlled on these devices through easy to reach preference panels. Of course, the natural language announcements would make use of one or more speakers either integral or externally connected to the device 2511, 2531, 2541, 2551.

To these natural language audio announcements, a client may respond with a set of commands using a microphone connected to the client device in use 2512, 2532, 2542, 2552 to perform simple notification related tasks. For example, “Show me.” may be used to open one or more virtual assistant related application windows and to display the full notification and the immediate background information on the default designated client display device, for example the client's desktop workstation, or the current device, if display capable. The client may also specify the device on which to display the desired information, for example “Show me on den computer.” 2530 or “Show me on my laptop.” 2550. The client may also stipulate simple items that she wants to investigate. For example, if the notification pertains to Stock X the client might say “Show me the performance of Stock X over past six months as a table of weekly end prices (on my laptop).” Or if the notification is that a stock of interest, “Stock Y” has reached a pre-decided buy or sell level, the client may say “Confirm sell Stock Y.” or “Confirm buy Stock Y.” or “Hold Stock Y, Show me Stock Y performance for past 6 months and expert opinion data for Stock Y.” Verbal commands can quickly reach complexity where traditional keyboard and icon interaction may be more efficient and some tasks may not lend themselves to efficient verbal description. Only a very small subset of useful verbal interaction have been disclosed here, but the invention may respond to any commands found useful to those skilled in the art.

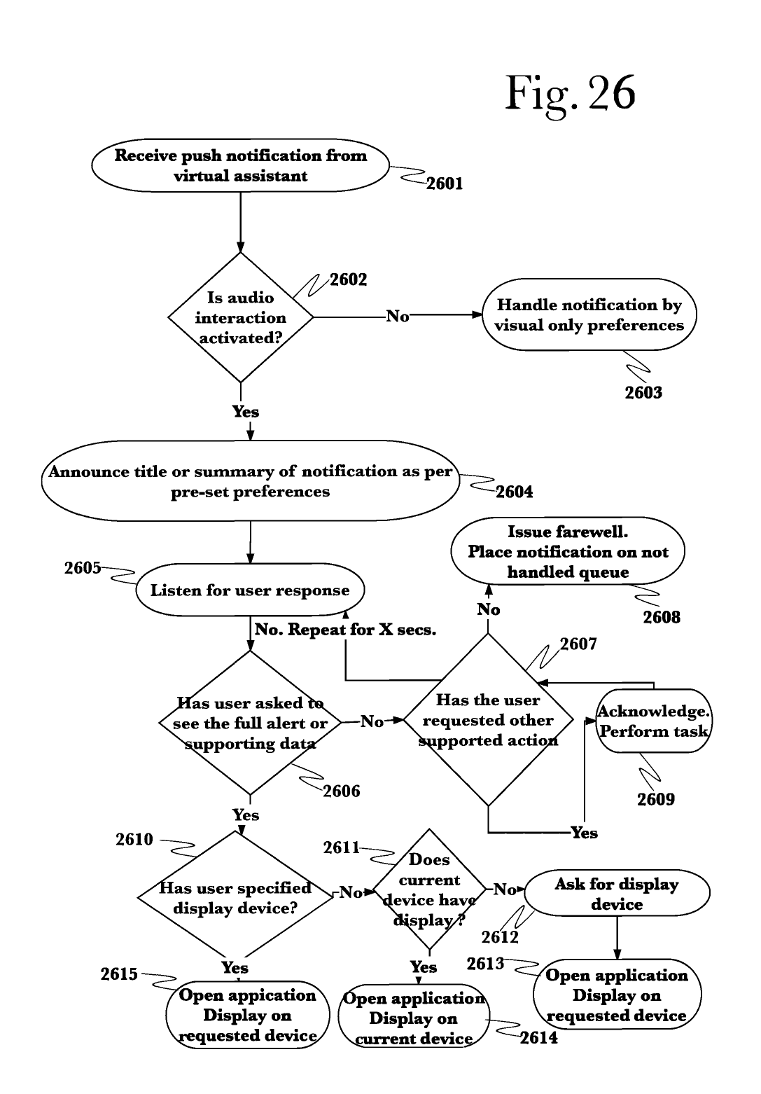

FIG. 26 is a flow diagram illustrating exemplary function of the mixed audio and visual interaction method available for financial information retrieval 2600 according to a preferred embodiment of the invention. Push notification information is received from the virtual assistant platform by one or more of the user's client devices 2601. If the client has audio interaction activated 2602 for an audio interaction capable device then that device will audibly announce some predetermined portion of the push notification which may be a title, or all or part of a summary according to pre-set client preferences 2604. Otherwise, normal visual only handling will take place according to client preferences, which may include an audio alert tone but no speech interaction 2603. The client device will then listen for the user's response in the form of a known command. If, after a certain no commands are received 2607, the notification will be labeled as unhandled 2608 which may be further processed per user preference choice. Valid voice commands may be the client asking to be shown the full notification and/or the supporting data 2606 otherwise, valid commands may request that other actions be taken such as, but not limited to: “Save until 3:00 pm.”, “Confirm sell Stock X”, “Show me expert opinion data for Stock X from last 6 months.”, or “Show performance data of Stock X for last 6 months as a line graph.” 2609 The system may be programmed to accept any verbal command known useful to one skilled in the art. The client may have multiple devices on which verbal command requested data may be displayed and may specify a display at the time of initial response such as: “Show me on den workstation.” 2610, in which case an application window will be opened on that device and focus shifted there 2615. If no client display device is specified and the device in current use has display capabilities 2611, it may be assumed by the system that visual results are to be shown there 2614. Otherwise, if no device is specified by the client 2610 and the current device does not have adequate display capabilities, the system may ask the client to specify a device 2612 on which to display the notification data 2613.

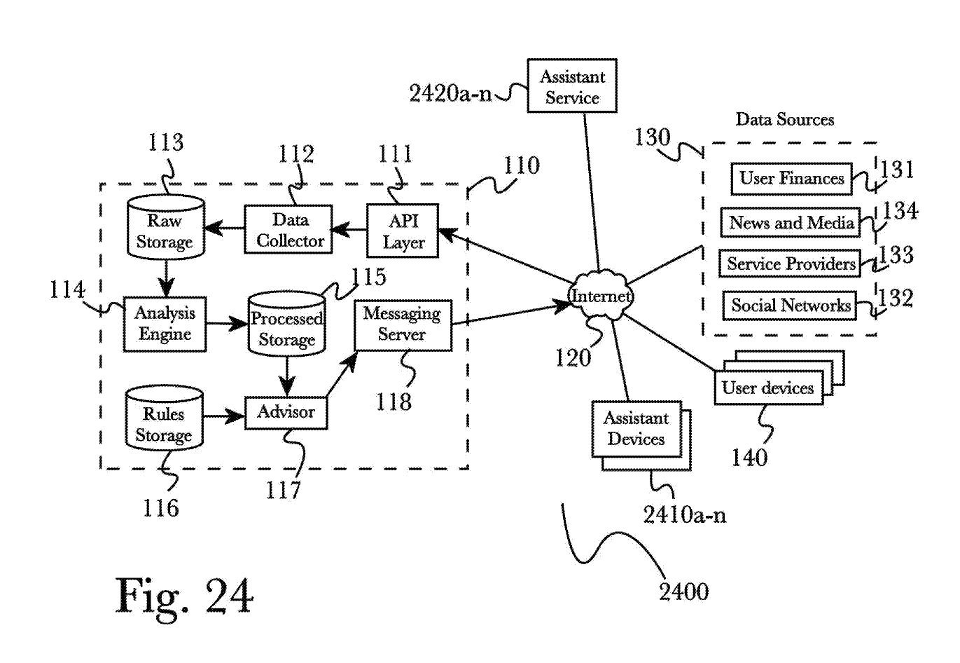

FIG. 24 is a block diagram of an exemplary system architecture 2400, illustrating the integration of a virtual assistant with deep analytics and proactive interaction with third-party virtual assistant products to extend their functionality. According to the embodiment, virtual assistant platform 110 may connect via the Internet 120 or other data communication network, to interact with a user device 140 (for example, a user's smartphone or computer) and a plurality of data sources 130 that may comprise a wide variety of information sources such as user financial accounts 131 (such as investment portfolios or bank accounts), social media profiles 132, accounts with service providers 133 such as public utilities or cloud services, news or other media sources 134, and other various sources of available information, whether public or private (with corresponding configuration for access). Data from sources 130 may be exposed using a plurality of application programming interfaces (APIs) 111 configured to facilitate communication between data sources 130 and a data collector 112 that receives raw data from connected data sources 130 and stores the data in a raw data storage database 113. This raw data may then be processed by an analysis engine 114 to produce entities for internal use such as to maintain a hierarchical structure as described below, as well as to identify any information changes such as new data or modifications to previously-received data (for example, when a stock price changes, or new posts are uploaded to a social media account, or new travel arrangements are made). Processed data may then be placed in a processed information storage database 115, which may optionally be a separate database structure or physical storage from a raw storage 113, or may simply be a logical separation within the same storage schema.

An intelligent advisor 117 may then retrieve processed data from storage 115 and load configured rules from a rules database 116 (such as rules governing a user's preferences for notifications, thresholds for determining whether a change is significant, timing for updates, or other such configuration information), and may analyze the data to identify relationships between data points (such as identifying that a user has family nearby a newly-booked travel destination, or that they have invested in a company that was mentioned in a recent news article) and to determine (optionally based on a plurality of configured rules) whether any particular change will impact related data entities and whether a user should be notified. For example, if a news article mentions a company in which the user holds stock, but it is only a passing reference, the user may not be notified as the implications of this observation are negligible. However, if a news article discusses a potential merger between companies, or a change in a product timeline, a user may be notified as this news may impact their stock. Notification prompts may then be provided to a messaging server 118 that may operate a plurality of messaging interfaces to accommodate a wide range of user preferences such as to communicate via email, SMS, SKYPE™, push notifications to a user's smartphone or other mobile device, or other such communication methods. Notifications may then be produced and transmitted via network 120 to a user's device 140 for review.

API layer 111 may operate a plurality of APIs configured to provide integration with third-party virtual assistant services 2420a-n or devices 2410a-n to extend their functionality, for example to provide deep analysis and proactive interaction to existing assistant technologies and to enable third parties to extend their own solutions by offering the additional functionality of a deep-analysis proactive virtual assistant system 110 within their own products. For example, a virtual assistant service 2420a-n such as MICROSOFT CORTANA™ may utilize proactive notification functionality using deep analysis, by incorporating a user's linked accounts and known information that is already available to the service, and applying the techniques and algorithms disclosed herein to uncover additional insights and offer proactive suggestions to users. For example, when a user is traveling near the home of a family member, they may be prompted to visit without having to manually input the family member's information or manually checking scheduling. In another example, a virtual assistant device 2410a-n such as AMAZON ECHO™ may be used to present proactive notifications and respond to user interaction in new ways using deep analysis to expand the device's capabilities beyond its original functions. For example, a user may ask an AMAZON ECHO™ device “How did my stocks do today?” and receive a meaningful, personalized response based on deep analysis of their portfolio. The device may also be used to deliver notifications, such as alerts based on situational awareness notifying the user of changes or events that may affect them, rather than traditional operation wherein such devices and services operate in a reactive-only operation mode, wherein a user must ask a question or otherwise interact in order to receive any form of feedback from the virtual assistant.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

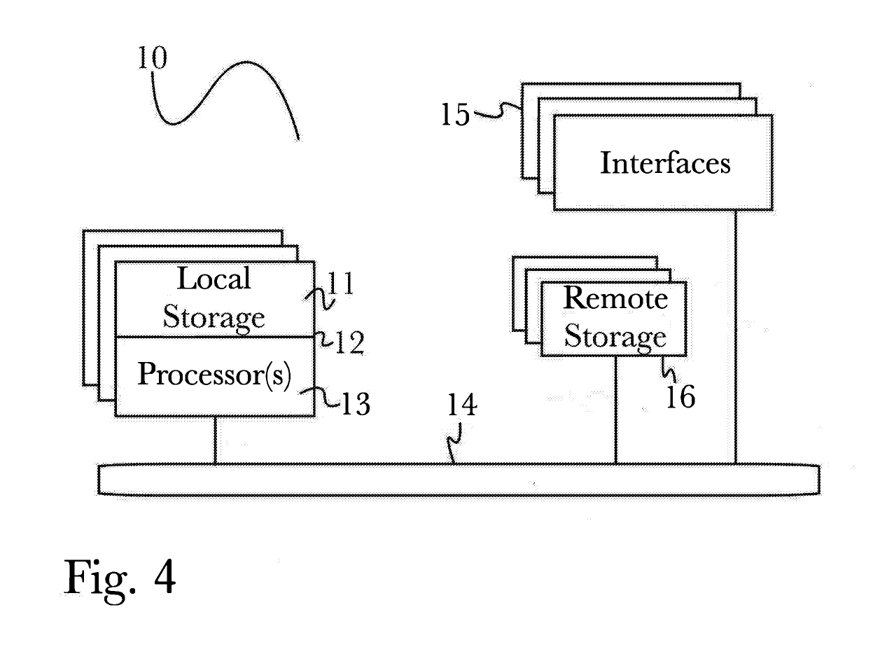

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 4 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

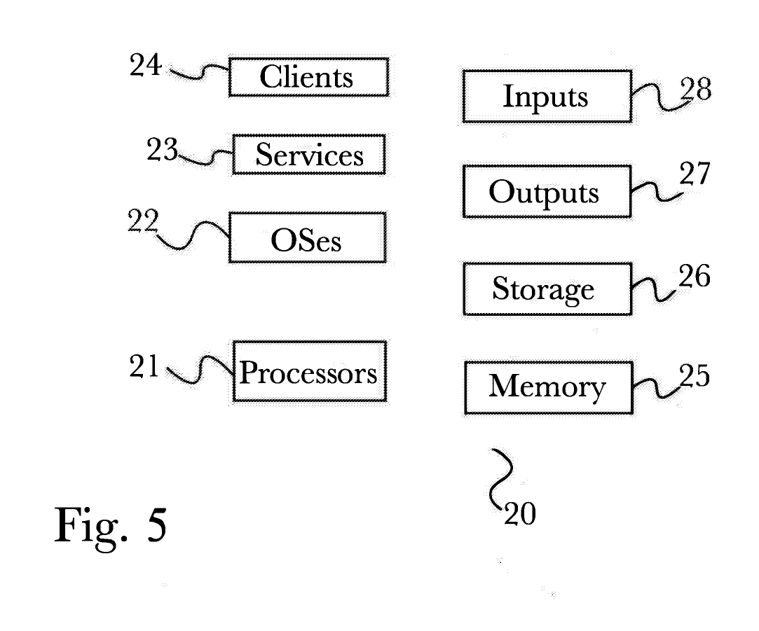

In some embodiments, systems according to the present invention may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

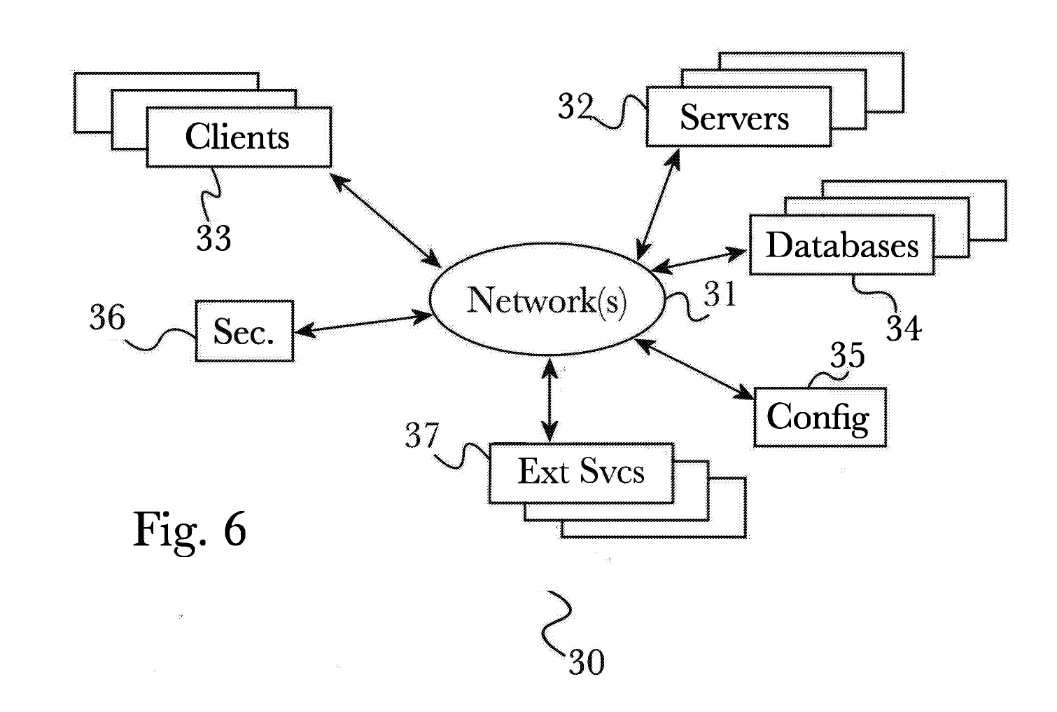

In some embodiments, systems of the present invention may be implemented on a distributed computing network, such as one having any number of clients and/or servers. Referring now to FIG. 6, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

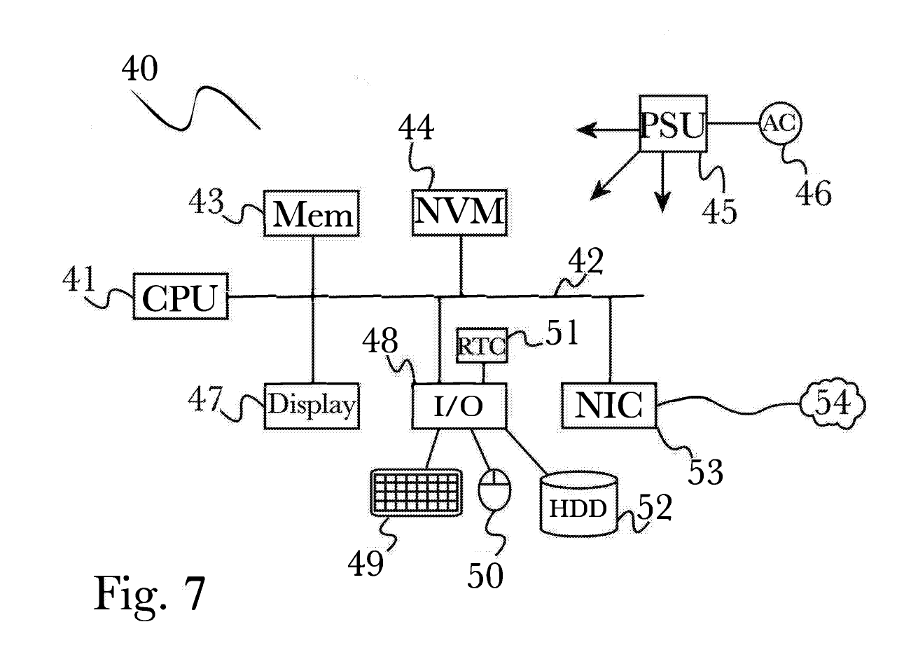

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for providing real-time multidevice messages to a user, comprising:
a first computing device comprising a memory, a processor, an audio input component, an audio output component, a wireless network interface, and a plurality of programming instructions operating in the memory and on the processor, the programming instructions configured to:
receive a verbal query from a user via the audio input device;
transmit the verbal query via a wireless network using the wireless network interface to a virtual assistant platform;
receive a query response message from the virtual assistant platform and provide the query response message to the user using the audio output device;
receiving a verbal instruction from the user to provide information visually; and
transmitting the verbal instruction to the virtual assistant platform; and
a second computing device comprising a memory, a processor, a display, an input means, a network interface, and a plurality of programming instructions operating in the memory and on the processor, the programming instructions configured to:
receive a data message from the virtual assistant platform via a network, the data message based at least in part on the verbal instruction from the user;
displaying graphically at least a portion of data from the received data message on the display;
receiving a user interaction event pertaining to the displayed data based on use of the input means; and
transmitting a message to the virtual assistant platform via the network based on the user interaction event.

2. The system of claim 1, wherein the virtual assistant platform comprises a plurality of software APIs, wherein at least a portion of query response comprises information retrieved from a plurality of external data sources via the plurality of APIs.

3. The system of claim 2, wherein at least a portion of the information retrieved from a plurality of external data sources comprises at least financial information.

4. The system of claim 3, wherein the financial information comprises historical investment data.

5. The system of claim 2, wherein at least a portion of the information retrieved from a plurality of external data sources comprises at least user behavior data.

6. The system of claim 5, wherein the query response comprises a recommendation based at least in part on at least a portion of the user behavior data.

7. A method for providing real-time multidevice messages to a user, comprising the steps of:
receiving, at a first computing device comprising a memory, a processor, an audio input component, an audio output component, a wireless network interface, and a plurality of programming instructions operating in the memory and on the processor, a verbal query from a user via the audio input device;
transmitting the verbal query via a wireless network using the wireless network interface to a virtual assistant platform;
receiving a query response message from the virtual assistant platform and provide the query response message to the user using the audio output device;
receiving a verbal instruction from the user to provide information visually;
transmitting the verbal instruction to the virtual assistant platform;
receiving, at a second computing device comprising a memory, a processor, a display, an input means, a network interface, and a plurality of programming instructions operating in the memory and on the processor, a data message from the virtual assistant platform via a network, the data message based at least in part on the verbal instruction from the user;
displaying graphically at least a portion of data from the received data message on the display;
receiving a user interaction event pertaining to the displayed data based on use of the input means; and
transmitting a message to the virtual assistant platform via the network based on the user interaction event.
